(19) United States
(12) Patent Application Publication
(10) Pub. No.: US 2007/0233804 A1
(43) Pub. Date: Oct. 4, 2007

(54) Providing remote application access in accordance with decentralized configuration information

(75) Inventors: Ashwin Palekar, Sammamish, WA (US); Ido M. Ben-Shachar, Kirkland, WA (US); Robert Kenneth Leitman, Duvall, WA (US); Russell S. Morgan, Seattle, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/395,905

(22) Filed: Mar. 31, 2006

(51) Int. Cl. G06F 15/16

(52) U.S. Cl. 709/208

(57) ABSTRACT

The present invention extends to methods, systems, and computer program products for providing remote application access in accordance with decentralized configuration information. Client side data representing a request for a list of remote applications is received. One or more lists of remote applications resident at terminal servers are accessed. Filter criteria to apply to the one or more lists of available remote applications are identified based on the client side data. The identified filter criteria are applied to the one or more lists of available remote applications to reduce the one or more lists of available remote applications to a targeted subset of remote applications. Application access data is returned for each remote application in the subset of remote applications to the client computer system such that the client computer system can use the application access data to remotely execute targeted remote applications.

### CROSS-REFERENCE TO RELATED APPLICATIONS

Not Applicable.

### BACKGROUND

### 1. Background and Relevant Art

Computer systems and related technology affect many aspects of society. Indeed, the computer system's ability to process information has transformed the way we live and work. Computer systems now commonly perform a host of tasks (e.g., word processing, scheduling, and database management) that prior to the advent of the computer system were performed manually. More recently, computer systems have been coupled to one another and to other electronic devices to form both wired and wireless computer networks over which the computer systems and other electronic devices can transfer electronic data. As a result, many tasks performed at a computer system (e.g., voice communication, accessing electronic mail, controlling home electronics, Web browsing, and printing documents) include the communication (e.g., the exchange of electronic messages) between a number of computer systems and/or other electronic devices via wired and/or wireless computer networks.

In many environments, a single computer user has multiple computing devices they use to perform computing tasks. For example, a corporate employee may have a work computer, a home computer, and a laptop. Each of these computer systems may be in and may move between different physical locations. For example, the work computer may be in a corporate building, the home computer may be in the employee's home, and the laptop may be in various different locations as the employee travels. However, the employee may desire uniform access to work related applications and work related data from any of their computer systems in any location.

Thus, it may be that all the applications installed at the work computer are also installed on the home computer and on the laptop. Installing the same applications on all of the employee's computer systems can provide a common look and feel across all the computer systems. Installing the same applications on all the employee's computer systems can also provide access to corporate applications and corporate data access in a uniform fashion across all of the computer systems. However, installing the same application on multiple computer systems also has a number of drawbacks.

A corporation supporting the applications may be required to have a license for each version of an application that is installed. Thus, if a computer user has three computer systems, the corporation is required, at least for some applications, to buy three licensed copies of the application. Additional license must be purchased even if some versions of an application (e.g., on a home computer) are used infrequently. Purchasing additional licenses increases the cost of providing employees with uniform access to corporate applications and corporate data.

Further, a corporation may have limited, if any, control over one or more of the employee's computer systems. For example, a corporation may have limited control over an employee's laptop (even if the laptop is corporate property), since the laptop may be used in various different physical locations (e.g., hotels, airports, etc.) at the discretion of the employee. A corporation may have essentially no control over an employee's home computer system, since the home computer system is in the employee's home. Thus, there is no way to insure that corporate security mechanisms (e.g., firewalls, SPAM filters, virus scanners, etc.) are used to protect one or more of an employee's computer systems, when those one or more computer systems access corporate applications and corporate data. Lack of access to corporate security mechanisms is problematic since a security breach to a non-corporate application or non-corporate data can cause corporate applications and data to be propagated. For example, a virus received in a personal e-mail at a home computer system can be propagated to corporate data when the corporate data is subsequently accessed at the home computer system.

Due at last in part to these cost and security concerns, many corporations (as well as other entities) use terminal servers and/or remote desktop access to provide remote access to applications and data. A terminal server is a computer system that maintains applications that can be remotely executed by client computer systems. A remote desktop allows remote access (e.g., from home) directly to a desktop computer in another location (e.g., in the office) through Virtual Private Network (“VPN”). Thus, in remote desktop environments, a corporation is not required to host applications on a central server.

Using either technology, input is entered at a client computer system (e.g., at home) and transferred over a network (e.g., using protocols based on the ITU T.120 family of protocols, such as, for example, Remote Desktop Protocol (“RDP”)), to an application (e.g., at the terminal server or the uses office computer). The application processes the input as if the input was entered locally. The application generates output in response to the received input and the output is transferred over the network e.g., also T.120 based protocols) to the client computer system. The client computer system presents the output data. Thus, input is received and output presented at the client computer system, while processing actually occurs at a terminal server or a remote desktop computer.

In most, if not all terminal server environments, input data (entered at a client computer system) typically includes mouse and keyboard data representing commands to an application and output data (generated by an application at the terminal server) typically includes video data for display on a video output device. Many terminal server environments also include functionality that extended protocols (e.g., developed to transfer input and output data) to transfer other types of data. For example, virtual channels can be used to extend the RDP protocol by allowing plug-ins to transfer data over an RDP connection. Many such extensions exist. For example, features such as printer redirection, clipboard redirection, port redirection, etc., use virtual channel technology.

However, for a client computer system to access a remote application from a remote desktop (either at a terminal server or another desktop computer), the client computer system must be provided with a link (e.g., electronic address and remote application initiation instructions in an RDP file) for accessing the remote application. Thus, even when using remote desktops, a user or administrator may be required to manually install a link for any remote applications a client computer system is to access.

Various mechanisms attempt to alleviate the burden of manually installing or authoring remote application links. At least some mechanisms, attempt to automate the installation of remote application links to a client computer system. For example, at least one mechanism pushes remote application links over a network to client computer systems. The remote application links can be presented at a corresponding user-interface in the form of an icon for selection by a user. However, these mechanisms require appropriate client modules for communicating with centralized configuration information for a terminal server domain. A client computer system that does not include the appropriate client modules may be unable to receive pushed remote application links.

Altering centralized configuration information for a domain can be cumbersome and can introduce security liabilities. Domain administrator permissions or approved delegate permissions are also typically required to modify centralized configuration information for a domain. However, a terminal serer administrator may have control over publishing applications. Thus, control over making an application available to users is split between the domain administrator and the terminal serer administrator.

A domain administrator may have some reluctance to allow other to modify the centralized configuration. Thus, it can be difficult a terminal server administrator to receive approval for altering and/or to alter centralized configuration information for their specific terminal server. As a result, it is also difficult for the terminal server administrator to be able to push remote application links for a specific remote application. That is, for a terminal server administrator to get a new application published to end-users they likely have to negotiate with the domain administrator to change the centralized configuration information. Also, when permissions are delegated to one who lacks appropriate training and knowledge, the possibility of introducing errors and security holes is increased.

Further, centralized configuration information must be updated each time a remote application is made available. Frequent access to centralized configuration information also increases the likelihood of introducing errors and/or security holes. Additionally, frequent access to centralized configuration information may be required to prevent remote application links from going stale. For example, it may that a remote application is removed from a terminal server but the centralized configuration information is not updated to reflect removal of the centralized application. Thus, a client computer may waste resources in continued attempts to access the remote application. Removal of a remote application can also be confusing to an end-user. For example, a user can click a link for a remote word processing program expecting to launch the program but instead receive an error message (indicating that the application is not available)

Other mechanisms are configured to provide remote application links through a Web based interface (and thus do not push remote application links to client computer systems). A user of client computer system directs a Web browser to Web site presented by a Web server that lists available remote application links (and potentially other content). Thus, these other mechanisms beneficially relieve a client computer system from having to maintain remote application links.

Instead, through the Web browser, a user selects a presented remote application link to activate a corresponding remote application. Subsequently, through appropriate communication at the client computer system, the selection is passed from the Web browser to client side-terminal server modules (e.g., a remote desktop client). The client side terminal modules then establish a terminal server connection (e.g. an RDP connection) to an appropriate terminal server to execute the remote application.

Although these Web based mechanisms are beneficial to client computer systems, they, at least to some extent, transfer the above-described client computer system problems to the Web servers that maintain remote application links. That is, adding a new remote application to an application list still requires updating centralized configuration information and pushing a corresponding link to a Web server. Also, failure to update centralized configuration information when remote applications are removed can cause a Web server to present stale remote application links. As a result, there is typically no way to easily create a Web portal front-end for a remote application server.

In some environments, centralized configuration information can be configured to filter application lists per individual users. Beneficially, individual filtering can reduce remote application links presented to a user's Web-browser to a manageable number of relevant links. Thus, an accounting employee can be presented a list of remote accounting applications in a format that is not cluttered with remote applications for other departments (e.g., human resources, engineering, etc.).

Unfortunately, remote application links are typically not filterable based on other criteria. For example, there may be no way to filter remote application links based on the Uniform Resource Locator (“URL”) of the Web site being accessed. Thus, any Web site configured to present remote application links for a user, would present all of the remote application links for the user, even if only a subset of the linked remote applications are relevant to the Web site.

For example, consider a corporation that publishes general applications like a word-processor, spreadsheet, etc. Now, consider a human-resources Website that simply wants to present an HR application to users that visit its website. The user will be very confused when they see the HR website showing both the general applications and the HR applications intermixed, instead of only the HR applications.

### BRIEF SUMMARY

The present invention extends to methods, systems, and computer program products for providing remote application access in accordance with decentralized configuration information. Client side data from a client computer system is received. The client side data includes at least an electronic address representing a request for a list of published remote applications targeted to user of the client computer system. One or more lists of available remote applications are accessed. Each list includes available remote applications resident at one or more terminal servers that are configured for remote execution over a terminal server connection between the client computer system and a corresponding terminal server.

Filters corresponding to each of the one or more terminal servers are accessed. Each filter includes filter criteria for filtering lists of available remote applications. Filter criteria to apply to the one or more lists of available remote applications are identified based on the client side data. The identified filter criteria are applied to the one or more lists of available remote applications to reduce the one or more lists of available remote applications to a targeted subset of remote applications. Application access data is returned for each remote application in the subset of remote applications to the client computer system such that the client computer system can use the application access data to remotely execute targeted remote applications.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates providing remote application access in accordance with decentralized configuration information.

FIG. 2 illustrates a flow chart of an example method for providing remote application access in accordance with decentralized configuration information.

FIG. 3 illustrates an example computer architecture that facilitates providing Web based access to remote applications

FIG. 4 illustrates an example connection sequence between various components of FIG. 3 that facilitates Web based access to remote applications.

FIG. 5 illustrates a second example connection sequence between various components of FIG. 3 that facilitates providing remote application access data.

FIG. 6 illustrates another example computer architecture that facilitates providing remote application access in accordance with decentralized configuration information.

### DETAILED DESCRIPTION

The present invention extends to methods, systems, and computer program products for providing remote application access in accordance with decentralized configuration information. Client side data from a client computer system is received. The client side data includes at least an electronic address representing a request for a list of published remote applications targeted to user of the client computer system. One or more lists of available remote applications are accessed. Each list includes available remote applications resident at one or more terminal servers that are configured for remote execution over a terminal server connection between the client computer system and a corresponding terminal server.

Filters corresponding to each of the one or more terminal servers are accessed. Each filter including filter criteria for filtering lists of available remote applications. Filter criteria to apply to the one or more lists of available remote applications are identified based on the client side data. The identified filter criteria are applied to the one or more lists of available remote applications to reduce the one or more lists of available remote applications to a targeted subset of remote applications. Application access data is returned for each remote application in the subset of remote applications to the client computer system such that the client computer system can use the application access data to remotely execute targeted remote applications.

Embodiments of the present invention may comprise a special purpose or general-purpose computer including computer hardware, as discussed in greater detail below. Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, computer-readable media can comprise computer-readable storage media, such as, RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

In this description and in the following claims, a “network” is defined as one or more data links that enable the transport of electronic data between computer systems and/or modules. When information is transferred or provided over a network or another communications connection (either hardwired, wireless, or a combination of hardwired or wireless) to a computer, the computer properly views the connection as a computer-readable medium. Thus, by way of example, and not limitation, computer-readable media can comprise a network or data links which can be used to carry or store desired program code means in the form of computer-executable instructions or data structures and which can be accessed by a general purpose or special purpose computer.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, hand-held devices, multi-processor systems, microprocessor-based or programmable consumer electronics, network PCs, minicomputers, mainframe computers, mobile telephones, PDAs, pagers, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

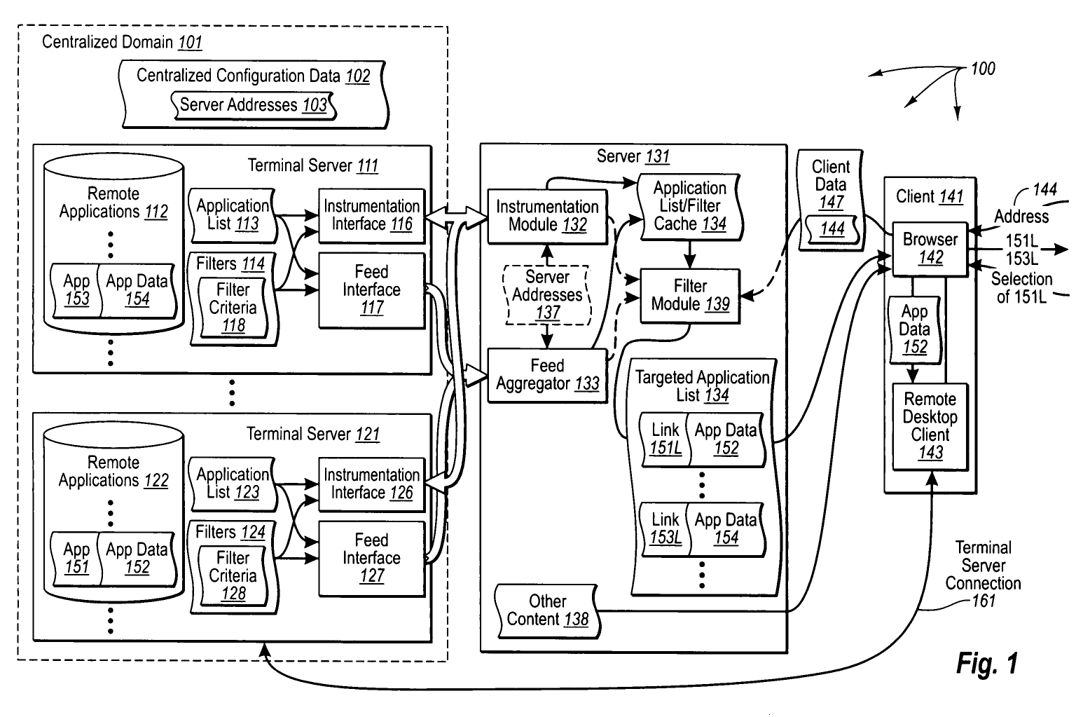

FIG. 1 illustrates an example computer architecture 100 that provides remote application access in accordance with decentralized configuration information. Computer architecture 100 includes centralized domain 100; server 131, and client 141. Components at and included in each of centralized domain 100, server 131, and client 141 can be connected to a network. The network can be any type of network, such as, for example, a Local Area Network (“LAN”), a Wide Area Network (“WAN”), or even the Internet. Thus, the various components at and included in centralized domain 100, server 131, and client 141 can receive data from and send data to each other, as well as other components connected the network. Accordingly, the components can create message related data and exchange message related data (e.g., Internet Protocol (“IP”) datagrams and other higher layer protocols that utilize IP datagrams, such as, Transmission Control Protocol (“TCP”), Remote Desktop Protocol (“RDP”), Hypertext Transfer Protocol (“HTTP”), Simple Object Access Protocol “SOAP”) etc.) over the network.

Generally, client 141 can be a computer system in communication with terminal servers (e.g., terminal servers 111 and 121) in centralized domain 101 for remote execution of applications at the terminal servers. Thus, input data (e.g., mouse and keyboard input) representing application commands can be received at client 101 and transferred over a network to terminal servers in centralized domain 101.

A receiving terminal servers then supplies the input data to the appropriate application (e.g., included in remote applications 112 and/or 122). The application generates output data, for example, display data, in response to the input data. The output display data can then transferred over the network to client 141. Client 141 can then display the display data at a display device. Thus, input is received and output presented at the client 141, while processing actually occurs at a terminal server.

Centralized domain 101 includes centralized configuration data 102 that stores configuration data for the various components of centralized domain 101. For example, centralized configuration data can be a portion of an Active Directory (“AD”) database that stores configuration data components for centralized domain 101. Thus, centralized configuration data 102 can include configuration information for terminal servers 111 and 121, such as, for example, server addresses 103, and any other components under that control of centralized domain 101. Server addresses 103 can store electronic addresses, such as, for example, Uniform Resource Locators (“URLs”) and/or IP addresses, for terminal servers in centralized domain. 101, including electronic addresses for terminal servers 111 and 121, feeds, and other locations that can be used to access application lists, filters, and filter criteria. External computer systems, such as, for example, server 131 and client 141, can obtain electronic addresses from server addresses 103 and use the electronic addresses to access application lists, filters, and filter criteria.

Terminal server 111 includes remote applications 112, application list 113, filters 114, instrumentation interface 116, and feed interface 117. Remote applications 112 can include one or more applications configured for remote execution over a terminal server connection (e.g., an RDP contention). Remote applications 112 can also store corresponding application data (e.g., installer files) that can be used by a client to initiated remote execution of an application. For example, app 153 can be stored along with app data 154. Application data can include executable instructions (e.g. a script) and configuration data for remotely executing an application. For example, app data 154 can include a script and configuration data for installing an appropriate link to app 153 at a client computer system such that the client computer system can access the link to remotely execute app 153.

Application list 113 includes a list of at least a portion of the applications stored in remote applications 112. For example, application list 113 can include an indication that app 153 is stored in remote applications 112. Terminal server 111 is configured to add, remove, and change data in application list 113. Thus, as applications are added to, removed from, and changed in remote applications 112, terminal server 111 can update application list 113 to reflect these additions, removals, and changes. Accordingly, a list of applications at terminal server 111 can be maintained without having to modify data in centralized configuration data 102.

Filters 114 include filter criteria 118. Portions of filter criteria 118 can be applied to application list 113 to filter listed remote applications from application list 113. For example, portions of filter criteria 118 can be applied to reduce application list 113 to subset of remote applications targeted to a specific client environment based on received client data. Filter criteria 118 can include name/value pairs (e.g., <name, value>) or name/value tuples (<name, value1, value2, . . . >) indicating how application list 113 is to be filtered based received client data. For example, filter criteria 118 can include a name/value pair or tuple that filters application list 113 for remote applications targeted to a specific URL. Filter criteria 118 can also include a name/value pair or tuple that filters application list 113 for remote applications targeted to specific user.

Filter criteria 118 can be applied singly. For example, a single name/value pair or tuple can be used to filter application list 113 to a subset of remote applications targeted to a specified URL. Filter criteria 118 can also be applied in combination with one another. For example, multiple name/value pairs and/or tuples can be used to filter application list 113 to a subset of remote applications targeted to a specified user and a specified URL.

Terminal server 111 is configured to add, remove, and change filters 114 and filter criteria 118. From time to time, other servers and clients can contact terminal server 111 to indicate remote applications of interest. As applications of interest are added, removed, and changed, terminal server 111 can update application filters 114 and filter criteria 118 to reflect these additions, removals, and changes. Accordingly, filters and filter criteria for filtering application list 113 can be maintained without having to modify centralized configuration data 102.

In some embodiments, application list 113, filters 114, and filter criteria 118 are at least partially maintained manually by an administrator of terminal server 111. Thus, when a new user is authorized to use a terminal server system, the administrator can add a filter and filter criteria for the user to filters 114 and filter criteria 118. For example, when a new human resources employee is added, an administrator can add filter criteria that cause application list 113 to be filtered to a subset of human resources applications when human resources employee requests a list of remote applications. Likewise, when a new Web site is added, the administrator can add a filter and filter criteria for the Web site to filters 114 and filter criteria 118. For example, when a payroll Web site is added, an administrator can add filter criteria that cause application list 113 to be filtered to a subset of payroll applications a list of remote applications through the payroll Web site.

Since application list 113, filters 114, and filter criteria 118 are maintained at terminal server 111, an administrator of terminal server 111 can modify the list of applications at terminal server 111 and data for filtering the list of applications without having to access (or even having permission to access) centralized configuration data 102.

Terminal server 121 is configured similarly to terminal server 111. Terminal server 121 includes remote applications 122, application list 123, filters 124, instrumentation interface 126, and feed interface 127. Remote applications 122 can include one or more applications configured for remote execution over a terminal server connection (e.g., an RDP contention). Remote applications 122 can also store corresponding application data (e.g., installer files) that can be used by a client to initiated remote execution of an application. For example, app 151 can be stored along with app data 152. App data 152 can include executable instructions and configuration data for remotely executing an application as previously described.

Application list 123 includes a list of at least a portion of the applications stored in remote applications 122. For example, application list 123 can include an indication that app 151 is stored in remote applications 122. Terminal server 121 is configured to add, remove, and change data in application list 123. Thus, as applications are added to, removed from, and changed in remote applications 122, terminal server 121 can update application list 123 to reflect these additions, removals, and changes. Accordingly, a list of applications at terminal server 121 can be maintained without having to modify centralized configuration data 102 (or any data at terminal server 111).

Filters 124 include filter criteria 128. Portions of filter criteria 128 can be applied to application list 123 to filter listed remote applications from application list 123. For example, portions of filter criteria 128 can be applied to reduce application list 123 to subset of remote applications targeted to a specific client environment based on received client data. For example, filter criteria 128 can used to filter application list 123 for a specified user and/or a specified URL. Filter criteria 128 can include name/value pairs and/or name/value tuples that can be applied singly or in combination as previously described.

As applications of interest are added, removed, and changed, (e.g., in response to communication with another computer system or administrator commands) terminal server 121 can update application filters 124 and filter criteria 128 to reflect these additions, removals, and changes. Accordingly, filters and filter criteria for filtering application list 123 can be maintained without having to modify centralized configuration data 102 (or any data at terminal server 111).

Since application list 123, filters 124, and filter criteria 128 are maintained at terminal server 121, an administrator of terminal server 121 can modify the list of applications at terminal server 121 and data for filtering the list of applications without having to access (or even having permission to access) centralized configuration data 102.

Any terminal server in centralized domain 101 can be configured to return a list of applications (filtered or unfiltered) to a requesting computer system using a plurality of different mechanisms. As depicted, terminal server 111 includes instrumentation interface 116 and feed interface 117. Similarly, terminal server 121 includes instrumentation interface 126 and feed interface 127.

Generally, an instrumentation interface (e.g., instrumentation interfaces 116 and 126) can be a management instrumentation interface that facilitates the management and control of computer systems, applications, and networks. An instrumentation interface can be used to query and set information for clients, applications, and networks. For example, instrumentation interface 116 can be used to query and set information for terminal server 111, remote applications 112, server 131, and client 141 (e.g., in application list 113, filters 114, and filter criteria 118, etc.). Similarly, instrumentation interface 126 can be used to query and set information for terminal server 121, remote applications 122, server 131, and client 141 (e.g., in application list 123, filters 124, and filter criteria 128, etc.).

In some embodiments, instrumentation interfaces are implementations of Web-Based Enterprise Management (“WBEM”) (e.g., Windows Management Interface (“WMI”)) for accessing management information in an enterprise environment. WBEM implementations can use a Common Information Model (“CIM”) to represent computer systems, applications, networks, devices, and other managed components.

Generally, a feed interface can be an interface for publishing information for clients, applications, and networks. For example, feed interface 117 can be used to publish information for terminal server 111, remote applications 112, server 131, and client 141 (e.g., in application list 113, filters 114, and filter criteria 118, etc.). Similarly, feed interface 127 can be used to publish information for terminal server 121, remote applications 122, server 131, and client 141 (e.g., in application list 123, filters 124, and filter criteria 128, etc.).

In some embodiments, feed interfaces are implementations of Rich Site Summary (“RSS”) feeds for syndicating content (application lists, filters, etc). For example, terminal servers 111 and 121 can create RSS documents and register the documents with an RSS publisher. Other computer systems (e.g., server 131) that can read RSS distributed content can then use the content.

As depicted, terminal servers 111 and 112 include both an instrumentation interface and a feed interface. However, in some embodiments, terminals servers include one or the other of these interfaces. For example, it may be that terminal server 111 includes an instrumentation interface but not a feed interface. On the other hand, it may be that terminal server 121 includes a feed interface but not an instrumentation interface. Terminal servers can also include other interfaces, in addition to feed interfaces and instrumentation interfaces, for transferring application lists, filters, and filter criteria from a terminal server to server 131.

Referring now to server 131, server 131 includes instrumentation module 132, feed aggregator 133, filter module 139, application list/filter cache 134, and other content 138. Instrumentation module 132 (e.g., a WBEM-based module) can interoperate with instrumentation interfaces 116 (as well as instrumentation interfaces at any other terminal servers) to query and set information. For example, instrumentation module 132 can interoperate with instrumentation interface 116 to query and set information for terminal server 111, remote applications 112, server 131, and client 141 (e.g., in application list 113, filters 114, and filter criteria 118, etc.). Similarly, instrumentation module 132 can interoperate with instrumentation interface 126 to query and set information for terminal server 121, remote applications 122, server 131, and client 141 (e.g., in application list 123, filters 124, and filter criteria 128, etc.).

Feed aggregator 133 (e.g., an RSS feed aggregator) can interoperate with feed interfaces 117 and 127 (as well as feed interfaces for other terminal servers) to receive and aggregate published information. For example, feed aggregator 133 can aggregate information published for terminal servers 111 and 112 (e.g., information in application list 113, filters 114, filter criteria 118, application list 123, filters 124, and filter criteria 128, etc.).

As depicted, server 131 includes both an instrumentation module and a feed aggregator. However, in some embodiments, a server 131 includes one or the other of these interfaces. For example, it may be that server 131 includes an instrumentation module but not a feed aggregator. On the other hand, it may be that server 131 includes a feed aggregator but not an instrumentation module. Server 131 can also include other interfaces, in addition to feed aggregators and instrumentation modules, for receiving application lists, filters, and filter criteria corresponding to a terminal server.

Server 131 can maintain application list/filter cache 134 containing application lists, filters, and filter criteria received from terminal servers over various different interfaces. Application list/filter cache 134 can be updated as new application lists, filters, and filter criteria are received.

Filter module 139 is configured to identify appropriate filter criteria for applying to received application lists based on received client data. Filter module 139 can extract portions of client data, such as, for example, a user ID or URL, and attempt to identify filter criteria that correspond to the extracted client data. In some embodiments, filter module 139 attempts to match extracted client data to the name portion of name/value pairs or the name portion of name/value tuples representing filter criteria. For example, if the use ID “UserA” is extracted from client data, filter module can search filter criteria for any name/value pairs having a name portion equal to “UserA”.

When appropriate filter criteria are identified, filter module 139 can apply the filter criteria to corresponding application lists to reduce the lists to a targeted subset of applications based on user ID, URL, etc.

Server 131 is configured to provide content to requesting clients. In response to receiving an electronic address (e.g. a URL) from a client, server 131 can return corresponding content to the client. Thus, in response to receiving a URL requesting a list of remote applications, server 131 can return links accessible to execute remote applications. Other content 138 includes content that is to be displayed, along with links for executing remote applications, to a user when a list of links for remote applications is returned. For example, if server 131 is Web server, other content 138 can include Web based content for presentation at a Web browser.

Server 131 can also include server addresses 137. Server address 137 can store electronic addresses (e.g., URL, IP address, etc.) for terminal servers, feeds, and other locations that can be accessed to obtained application lists, filters, and filter criteria for terminal servers. In some embodiments, server 131 refers to server addresses 102 to obtain electronic addresses. For example, instrumentation module 132 can refer to server addresses 103 to obtain an electronic address for instrumentation interface 116. In other embodiments, server 131 is configured to include server addresses 137. Thus, server 131 can refer to server addresses 137 to obtain electronic address. For example, feed aggregator 133 can refer to server addresses 137 to obtain an electronic address for a feed output by feed interface 127. Thus, through indirection to centralized configuration data 102 modules of server 131 can access modules of terminal servers 111 and 121.

Client 141 includes browser 142 and remote desktop client 143. Browser 142 is configured to receive electronic address (e.g., URLs) corresponding to content of server 131. Browser 142 can receive manual entered electronic address as well as addresses received in response to selecting a link (e.g., from appropriate input devices). Browser 142 can submit electronic address to server 131 as a request for content from server 131. Browser 142 can present any content returned in response to a request at appropriate output devices.

It may be that in response to a request for content, browser 142 receives one or more links to remote applications as well as application data for remotely executing the remote applications. If a link for a remote application is subsequently selected, browser 142 can transfer application data for the remote application to remote desktop client 143. Remote desktop client 143 can use the application data to establish a terminal server connection (e.g., an RDP connection) to the terminal server that includes the remote applications. The remote application can then be remotely executed over the terminal server connection.

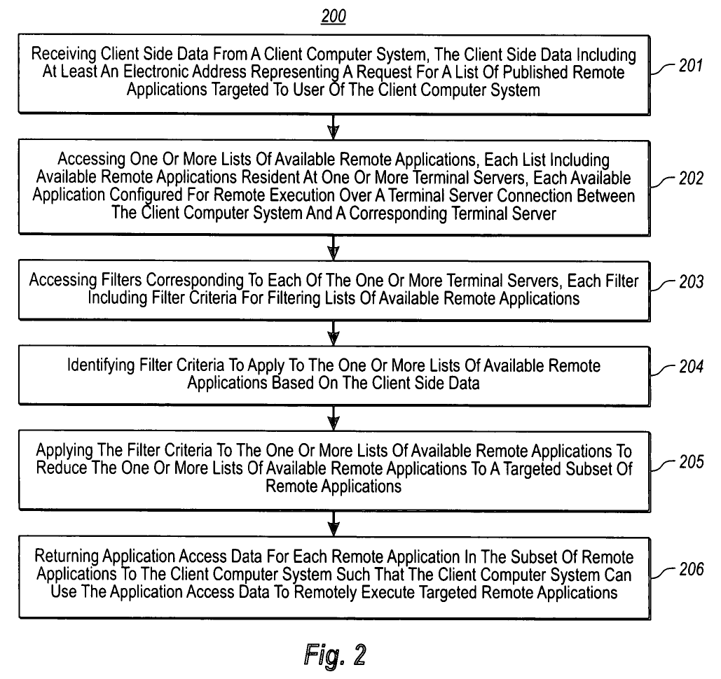

FIG. 2 illustrates a flow chart of an example method 200 for providing remote application access in accordance with decentralized configuration information. Method 200 will be described with respect to the components and modules depicted in computer architecture 100.

Method 200 includes an act of receiving client side data from a client computer system (act 201). The client side data includes at least an electronic address representing a request for a list of published remote applications targeted to user of the client computer system. For example, server 131 can receive client data. 147, including address 144 (e.g., a URL), from browser 142. Address 144 can be a request to access content, including a list of remote applications, entered by a user of client 141. In some embodiments, client data 147 can also include user credentials (e.g., user ID and password) used to identify and authenticate the user of client 141. In other embodiments, client 141 is associated with a specified user. In these other embodiments, it can be inferred upon receiving client data from client 141 that the user of client 141 is the specified user.

Address 144 can initially be received in the form of user input at browser 142. Browser 142 can combine address 144 along with other appropriate data, such as, for example, an electronic address of client 141 and user credentials, into client data 147. From client data 147, server 131 can identify (and potentially authenticate) the user of client 141 that caused address 144 to be sent from client 141 to server 131. Server 131 can transfer client data 147 to filter module 139

Method 200 includes an act of accessing one or more lists of available remote applications (act 202). Each list includes available remote applications resident at one or more terminal servers. Each available application is configured for remote execution over a terminal server connection between the client computer system and a corresponding terminal server. For example, filter module 139 can access application lists 113 and 123 in response to receiving address 144. Application list 113 can include a list of remote applications stored in remote applications 112. Application list 123 can include a list of remote applications stored in remote applications 122. Each of the applications stored in remote applications 112 and 122 can be configured for remote execution over a terminal server connection between client 141 and terminal servers 111 and 121 respectively.

Filter module 139 can access application lists 113 and 123 through any available interfaces. For example, through instrumentation module 132, filter module 139 can access at least portions of application list 113 and/or application list 123 respectively. Alternately or in combination, through feed aggregator 133, filter module 139 can access at least portions of application list 113 and/or application list 123 from content feeds associated with feed interfaces 116 and 117 respectively. Alternately or in combination, filter module 139 can also access portions of application list 113 and/or application list 123 from application list/filter cache 134.

When appropriate, server 131 can obtain an electronic address for terminal server 111 and/or terminal server 112 from server address 103. Alternately or in combination, server 131 can also obtain an electronic address for terminal server 111 and/or terminal server 112 from server address 137. Obtained terminal server addresses can be used by instrumentation interface 132 to contact instrumentation interface 116 and/or instrumentation interface 126. Alternately or in combination, obtained terminal server addresses can be used by feed aggregator 133 to contact content feeds associated with feed interface 117 and/or feed interface 127.

Method 200 includes an act of accessing filters corresponding to each of the one or more terminal servers (act 203). Each filter includes filter criteria for filtering lists of available remote applications. For example, filter module 139 can access filters 114 and 124 in response to receiving address 144. Filters 114 includes filter criteria 118 for filtering application list 113. Filters 124 includes filter criteria 128 for filtering application list 123.

Filter module 139 can access filters 114 and 124 through any available interfaces. For example, through instrumentation module 134, filter module 139 can access can at least portions of filter criteria 118 and 128 respectively. Alternately or in combination, through feed aggregator 133, filter module 139 can access at least portions of filter criteria 118 and 128 from content feeds associated with feed interfaces 116 and 117 respectively. Alternately or in combination, filter module 139 can also access at least portions of filter criteria 118 and 128 from application list/filter cache 134.

Method 200 includes an act identifying filter criteria to apply to the one or more lists of available remote applications based on the client side data (act 204). For example, filter module 139 can identify portions of filter criteria 118 to apply to application list 113 and can identify portions of filter criteria 128 to apply application list 123. Filter module can scan filter criteria 118 and filter criteria 128 to attempt to identify filter criteria that corresponding to address 144 (e.g., matching address 144 to the name portion of name/value pairs or name/value tuples).

Method 200 includes an act of applying the identified filter criteria to the one or more lists of available remote applications to reduce the one or more lists of available remote applications to a targeted subset of remote applications (act 205). For example, filter module 139 can apply identified value portions of filter criteria 118 to application list 113 and can apply identified value portions of filter criteria 128 to application list 113 to reduce application lists 113 and 123 to targeted application list 136. Thus, filter module 139 can reduce application lists 113 and 123 to a subset of remote applications for presentation at a specified Web site (at address 144).

Targeted application list 136 includes links and application data for executing each targeted remote application. For example, targeted application list 136 includes link 151L and app data 152 for executing app 151 and link 153L and app data 154 for executing app 153.

Method 200 includes an act of returning application access data for each remote application in the subset of remote applications to the client computer system such that the client computer system can use the application access data to remotely execute targeted remote applications (act 206). For example, filter module 139 can return targeted application list 136 (possibly along with content from other content 138) to browser 142. Client 141 can use link 151L and app data 152 to remotely execute app 151 and can use link 153L and app data 154 to remotely execute app 153. Accordingly, browser 142 is provided a list of applications that have been filtered for presentation at a specified Web site (at address 144).

Alternately, filter module can return a reduced set of information including, for example, just a list of icons (e.g., link 151L, ink 153L, etc) and application names (e.g., a subset of app data 152, a subset of app data 154, etc.)

Browser 142 can present links 151L and 153L at an output device of client 141. A user can then select a link to initiate remote execution of a corresponding remote application. For example, a user can select link 151L to initiate remote execution of app 151.

When a reduced set of information is initially received at browser 142, selection of a link can cause a new request for application data to be transmitted to server 131. For example, selection of link 151L can cause a request for the remainder of app data 152 to be transmitted to server 131. In response to the new request, server 131 can return additional application data back to browser 142. For example, server 131 can return any previously unsent portions of app data 152 to browser 142. Accordingly, network bandwidth can be conserved.

In response to receiving a selection of link 151L, browser 142 can forward app data 152 to remote desktop client 143. Remote desktop client 143 can use app data 152 to establish terminal server connection 161 (e.g., an RDP connection) to terminal server 121. Remote desktop client 143 can then execute app 151 over terminal server connection 161. Executable instructions (e.g., a script) in app data 152 can be executed to install an appropriate client side module for communicating with app 151.

Accordingly, embodiments of the present invention can be used to provide a Web front-end to published terminal server applications. A Web front-end can be run on the same computer system as a terminal server. Running both a terminal server and a Web front-end on the same computer system can reduce deployment costs. Alternately, a Web front-end and a terminal can be run on different computer system.

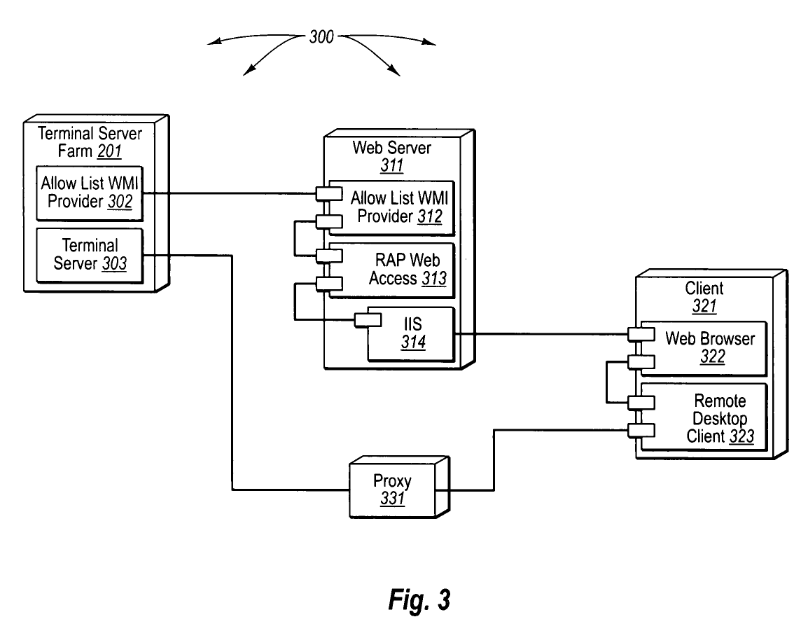

FIG. 3 illustrates a example computer architecture 300 that facilitates providing Web based access to remote applications. As depicted, architecture 300 includes terminal server farm 301, Web server 311, client 321, and proxy 331.

Terminal server farm 310 includes allow list WMI provider 302 and terminal server 303. Web server 311 includes allow list WMI provider 312, Remote Access Protocol (“RAP”) Web access 312, and Internet Information Server (“IIS”) 314. Client 321 includes Web browser 322 and remote desktop client 323.

Terminal server 303 is configured to server remote applications (e.g., over RDP) to clients. Allow list WMI providers 302 and 312 can communicate using WMI protocols to return a list of applications available on terminal server 303 to Web server 311. IIS 314 provides authentication, threading, and HTTP handling. RAP Web access accepts requests (through IIS) for published applications, looks up appropriate information, and returns a list of targeted applications.

Web browser 322 receives user input and presents content, including links to remote applications. Remote desktop client 323 is configured to present remote applications to a user. It communications with terminal server 303 and can include a sub-component to traverse firewalls. Proxy 331 is one of a variety of mechanisms used to navigate firewalls. Proxy 331 can be configured to receive HTTP, convert HTTP to RDP, and forward RDP to terminal server 303.

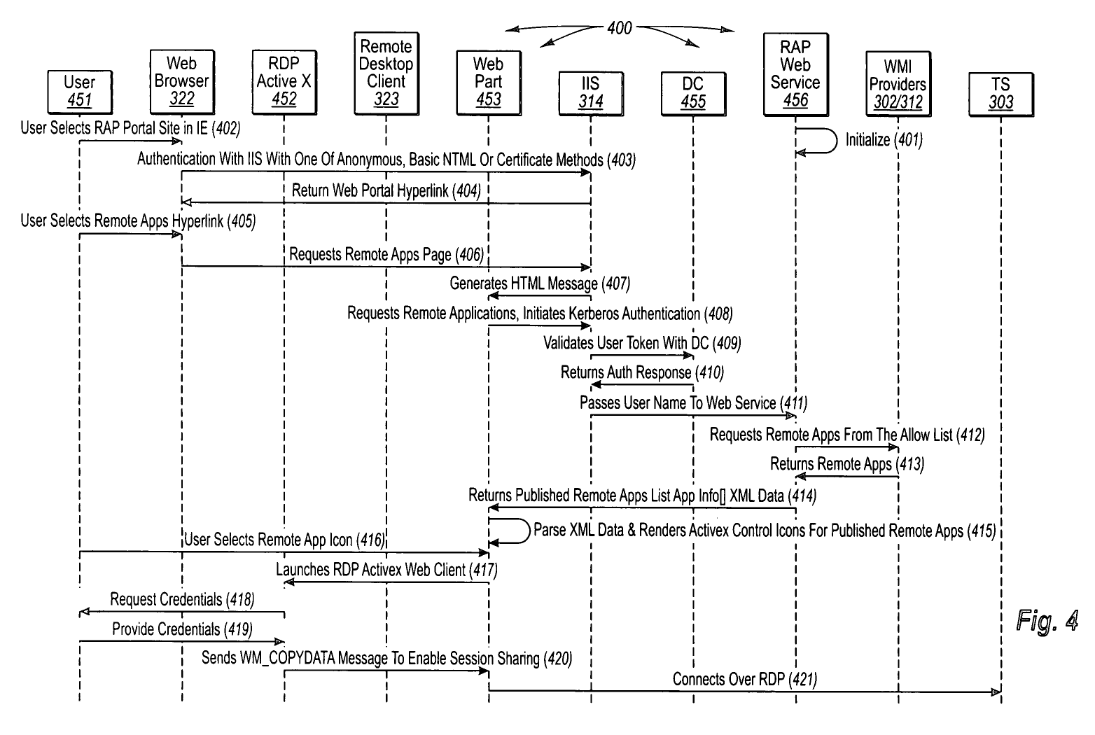

FIG. 4 illustrates an example connection sequence between various components of FIG. 3 that facilitates Web based access to remote applications. RAP Web service 456 is initialized (act 401). Using Web browser 322, user 451 selects a RAP site (act 402). Web browser 322 authenticates with IIS 314 using, for example, anonymous, basic, NTLM, or Certificate methods (act 403). IIS 314 returns a remote applications Web portal hyperlink to Web browser 322 (act 404). Web browser 322 displays the hyperlink. User 451 selects the remote applications hyperlink (act 405). Web browser 322 requests a remote applications Web page from IIS 314 (act 406).

IIS 314 sends an HTML message to Web part 453 (act 407). Web part 453 request remote applications and initiates Kerberos authentication with IIS 314 (act 408). ISS 314 validates a user token with DC 455 (act 409). DC 455 returns an authorization response to IIS 314 (act 410). IIS 314 passes a user name to RAP Web service 456 (act 411). RAP Web service 456 requests remote applications from the allow list from WMI providers 302/312 (act 412).

WMI providers 302/312 returns a list of remote applications to remote Web server 456 (act 413). Remote Web server 456 returns a XML data representing a published remote applications list to Web part 453 (act 414). Web part 453 parses the XML data and renders ActiveX® control icons for published applications (act 415).

User 451 selects a rendered remote application icon (act 416). Web part 453 launches an RDP ActiveX Web client 452 (act 417). RDP ActiveX 452 requests credentials from user 451 (act 418). User 451 provides credentials to RDP ActiveX 452 (act 419). RDP ActiveX 452 sends a WM_COPYDATA message to enable session sharing to remote desktop client 323 (act 420). Remote desktop client 323 connects to terminal server 303 over RDP (act 421).

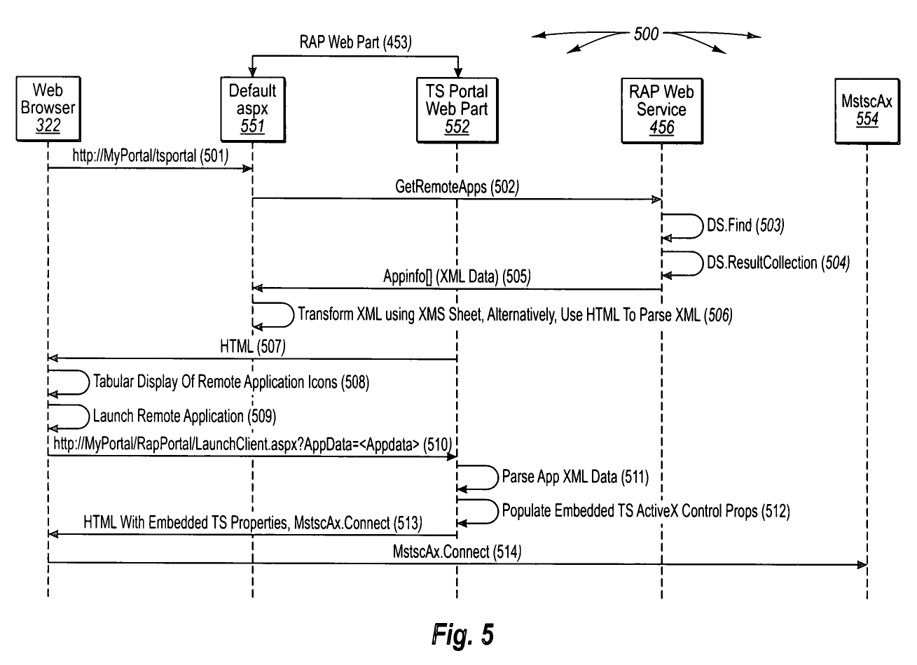

FIG. 5 illustrates a second example connection sequence between various components of FIG. 3 that facilitates providing remote application access data. Web browser 322 selects a Web portal for remote applications to default.aspx 551 (act 501). Default.aspx 551 issues a GetRemoteApps( ) call RAP Web Service 456 (act 502). RAP Web service 456 finds and collects a list of remote applications (acts 503 and 504). Rap Web service 456 sends XML data representing the list of remote applications to default.aspx 551 (act 505). Default.aspx 551 transforms the XML data using an XSL style sheet or alternatively uses HTML to parse the XML data (act 506).

Default.aspx 551 sends HTML to Web browser 322 (act 507). Web browser presents a tabular display of remote application icons (act 508). Web browser 322 launches a remote application (act 509). Web browser 322 sends appropriate application data TS portal Web part 552 to initiating the remote application (act 510). TS portal Web part 552 parses XML application data and populates embedded terminal server ActiveX® control properties (acts 511 and 512). TS portal Web part 552 sends HTML with the embedded terminal server properties to Web browser 322 (act 513). Web browser 322 utilizes an ActiveX® control to connect to MstscAx 554 (act 514).

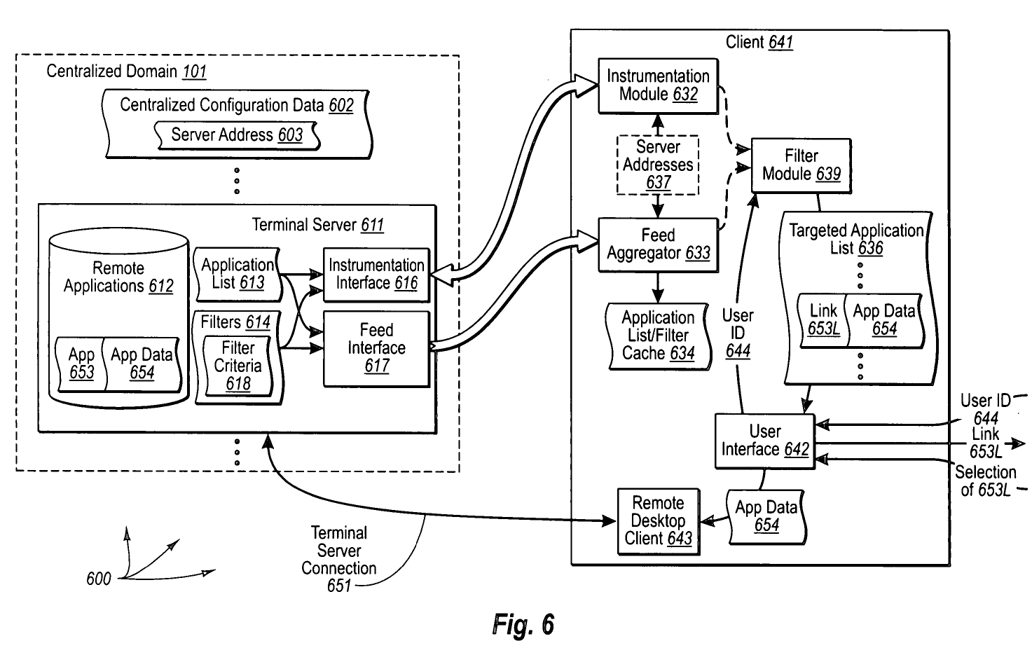

In some embodiments, a client interfaces directly with a centralized domain to provide remote application access in accordance with decentralized configuration information (alleviating the need for an intervening Web server). FIG. 6 illustrates computer architecture 600 that facilitates providing remote application access in accordance with decentralized configuration information.

As depicted, computer architecture 600 includes centralized domain 601 and client 641. Centralized domain 601 includes centralized configuration data 602 that stores configuration data for the various components of centralized domain 601. For example, centralized configuration data can be a portion of an Active Directory (“AD”) database that stores configuration data components for centralized domain 601. Thus, centralized configuration data 602 can include configuration information for terminal server 611, such as, for example, server addresses 603, and any other components under that control of centralized domain 601. Server addresses 603 can store electronic addresses, such as, for example, Uniform Resource Locators (“URLs”) and/or IP addresses, for terminal servers in centralized domain, including terminal servers 611, feeds, and other locations that can be used to access application lists, filters, and filter criteria. External computer systems, such as, for example, client 641, can obtain electronic addresses from server addresses 603 and use the electronic addresses to access application lists, filters, and filter criteria.

Terminal server 611 is configured similarly to terminal server 111. Terminal server 611 includes remote applications 612, application list 613, filters 614, instrumentation interface 616, and feed interface 617. Remote applications 612 can include one or more applications configured for remote execution over a terminal server connection (e.g., an RDP contention). Remote applications 612 can also store corresponding application data (e.g., installer files) that can be used by a client to initiated remote execution of an application. For example, app 653 can be stored along with app data 654. App data 654 can include executable instructions and configuration data for remotely executing an application as previously described.

Application list 613 includes a list of at least a portion of the applications stored in remote applications 612. For example, application list 613 can include an indication that app 653 is stored in remote applications 612. Terminal server 611 is configured to add, remove, and change data in application list 623. Thus, as applications are added to, removed from, and changed in remote applications 612, terminal server 611 can update application list 613 to reflect these additions, removals, and changes. Accordingly, a list of applications at terminal server 611 can be maintained without having to modify centralized configuration data 602 (or any data at terminal server 611).

Filters 614 include filter criteria 618. Portions of filter criteria 618 can be applied to application list 613 to filter listed remote applications from application list 613. For example, portions of filter criteria 618 can be applied to reduce application list 613 to subset of remote applications targeted to a specific client environment based on received client data. For example, filter criteria 618 can used to filter application list 613 for a specified user and/or a specified URL. Filter criteria 618 can include name/value pairs and/or name/value tuples that can be applied singly or in combination as previously described.

As applications of interest are added, removed, and changed, (e.g., in response to communication with another computer system or administrator commands) terminal server 611 can update application filters 614 and filter criteria 128 to reflect these additions, removals, and changes. Accordingly, filters and filter criteria for filtering application list 613 can be maintained without having to modify centralized configuration data 6022 (or any data at terminal server 611).

Since application list 613, filters 614, and filter criteria 618 are maintained at terminal server 611, an administrator of terminal server 611 can modify the list of applications at terminal server 611 and data for filtering the list of applications without having to access (or even having permission to access) centralized configuration data 602.

Similar to instrumentation interfaces 116 and 126, instrumentation interface 616 can be a management instrumentation interface that facilitates the management and control of computer systems, applications, and networks as previously described. Similar to feed interfaces 117 and 127, feed interface 617 can be an interface for publishing information for clients, applications, and networks. As depicted, terminal servers 611 includes both an instrumentation interface and a feed interface. However, in some embodiments, a terminals server includes one or the other of these interfaces.

Referring now to client 641, client 641 includes instrumentation module 632, feed aggregator 633, filter module 639, application list/filter cache 634, user interface 642, and remote desktop client 643. Instrumentation module 632 can interoperate with instrumentation interface 616 (as well as instrumentation interfaces at any other terminal servers) to query and set information. For example, instrumentation module 632 can interoperate with instrumentation interface 616 to query and set information for terminal server 611, remote applications 612, and client 641 (e.g., in application list 613, filters 614, and filter criteria 618, etc.).

Similar, to feed aggregator 133, feed aggregator 633 can interoperate with feed interface 617 (as well as feed interfaces for other terminal servers) to receive and aggregate published information. For example, feed aggregator 633 can aggregate information published for terminal server 611 (e.g., information in application list 613, filters 614, and filter criteria 618, etc.).

As depicted, client 641 includes both an instrumentation module and a feed aggregator. However, in some embodiments, a client 641 includes one or the other of these interfaces. For example, it may be that client 641 includes an instrumentation module but not a feed aggregator. On the other hand, it may be that clients 641 includes a feed aggregator but not an instrumentation module. Client 641 can also include other interfaces, in addition to feed aggregators and instrumentation modules, for receiving application lists, filters, and filter criteria corresponding to a terminal server.

Client 641 can maintain application list/filter cache 634 containing application lists, filters, and filter criteria received from terminal servers over various different interfaces. Application list/filter cache 634 can be updated as new application lists, filters, and filter criteria are received.

User interface 642 is configured to receive user IDs corresponding to users of client 641. User interface 642 can receive manual entered user IDs as well as user IDs received in response to selecting a link (e.g., from appropriate input devices). User interface 642 can submit user IDs to filer module 639 as a request for a list of remote applications. User interface 642 can present any listed applications returned in response to a request.

Filter module 639 is configured to identify appropriate filter criteria for applying to received application lists based on received client data. Filter module 639 can extract portions of client data, such as, for example, user ID 644, and attempt to identify filter criteria that correspond to the extracted client data. In some embodiments, filter module 639 attempts to match extracted client data to the name portion of name/value pairs or the name portion of name/value tuples representing filter criteria. For example, if the user ID 644 is extracted from client data, filter module 639 can search filter criteria for any name/value pairs having a name portion equal to user ID 644.

When appropriate filter criteria are identified, filter module 639 can apply the filter criteria to corresponding application lists to reduce the lists to a targeted subset of applications based on user ID, etc. For example, filter module 639 can apply identified filter criteria (from filter criteria 618) to application list 613 to reduce application list 613 to targeted application list 636. Targeted application list 636 includes links and application data for executing targeted remote applications. For example, targeted application list 636 includes link 653L and app data 654 for executing app 653. Thus, in response to receiving user ID 644, filter module 639 can return links for executing remote applications.

Accordingly, it may be that in response to a request for remote applications, user interface 642 receives one or more links to remote applications as well as application data for remotely executing the remote applications. User interface 652 can present any received links, such as, for example, link 653L, at an output device.

If a link for a remote application, such as, for example, link 653L, is subsequently selected, user interface 642 can transfer application data for the remote application to remote desktop client 643. For example, user interface 642 can transfer app data 654 o remote desktop client 643. Remote desktop client 643 can use app data 654 to establish terminal server connection 651 (e.g., an RDP connection) to terminal server 611. App 653 can then be remotely executed over terminal server connection 651.

Client 641 can also include server addresses 637. Server address 637 can store electronic addresses (e.g., URL, IP address, etc.) for terminal servers, feeds, and other locations that can be accessed to obtained application lists, filters, and filter criteria for terminal servers. In some embodiments, client 641 refers to server addresses 602 to obtain electronic addresses. For example, instrumentation module 632 can refer to server addresses 603 to obtain an electronic address for instrumentation interface 616. In other embodiments, client 641 is configured to include server addresses 637. Thus, client 641 can refer to server addresses 637 to obtain electronic address. For example, feed aggregator 633 can refer to server addresses 637 to obtain an electronic address for a feed output by feed interface 617.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system, a method for providing remote application access in accordance with decentralized configuration information, the method comprising:
an act of receiving client side data from a client computer system, the client side data including at least an electronic address representing a request for a list of published remote applications targeted to user of the client computer system;
an act of accessing one or more lists of available remote applications, each list including available remote applications resident at one or more terminal servers, each available application configured for remote execution over a terminal server connection between the client computer system and a corresponding terminal server;
an act of accessing filters corresponding to each of the one or more terminal servers, each filter including filter criteria for filtering lists of available remote applications;
an act of identifying filter criteria to apply to the one or more lists of available remote applications based on the client side data;
an act of applying the identified filter criteria to the one or more lists of available remote applications to reduce the one or more lists of available remote applications to a targeted subset of remote applications; and
an act of returning application access data for each remote application in the subset of remote applications to the client computer system such that the client computer system can use the application access data to remotely execute targeted remote applications.

2. The method as recited in claim 1, wherein the act of receiving client side data from a client computer system comprises an act of a Web server receiving the client side data.

3. The method as recited in claim 1, wherein the act of receiving client side data from a client computer system comprises an act of a user-interface at a the client computer system receiving at least one of a user identifier and a selection of a link to a remote application.

4. The method as recited in claim 1, wherein the act of receiving client side data comprises an act of receiving one or more of a user ID and a URL.

5. The method as recited claim 1, wherein the act of accessing one or more lists of available remote applications comprises an act of accessing one more lists of available remote applications through an instrumentation interface.

6. The method as recited claim 1, wherein the act of accessing one or more lists of available remote applications comprises an act of accessing one more lists of available remote applications through a publication feed interface.

7. The method as recited claim 1, wherein the act of accessing one or more lists of available remote applications comprises an act of accessing one more lists of available remote applications from a application list cache.

8. The method as recited in claim 1, wherein the an act of accessing filters corresponding to each of the one or more terminal servers comprises an act of accessing filters form one or more of an instrumentation interface, a publication feed interface, and a filter cache.

9. The method as recited in claim 1, wherein the act of identifying filter criteria to apply to the one or more lists of available remote applications based on the client side data comprises an act of matching a URL to a name portion of a name/value pair filter criteria.

10. The method as recited in claim 1, wherein the act of identifying filter criteria to apply to the one or more lists of available remote applications based on the client side data comprises an act of matching a user ID to a name portion of a name/value pair filter criteria.

11. The method as recited in claim 1, wherein the act of applying the identified filter criteria to the one or more lists of available remote applications to reduce the one or more lists of available remote applications to a targeted subset of remote applications comprises an act of reduce the lists of remote applications to a list at targeted to a specified URL.

12. The method as recited in claim 1, wherein the act of returning application access data for each remote application in the subset of remote applications to the client computer system comprises an act of returning scripts that can be used to install client side portions of the remote applications in the targeted subset.

13. The method as recited in claim 1, further comprising:
an act of accessing a list of server address that includes addresses for the one or more terminal servers;
an act of obtaining addresses for the one or more terminal servers from the list.

14. The method as recited in claim 1, further comprising:
an act of presenting selectable links for each remote application in the subset of remote applications;
an act of receiving a selection of a selectable link for one of the remote applications;
an act of forwarding application data corresponding to the remote application to a remote desktop client; and
an act of the remote desktop client using to application data to establish a terminal server connection to the terminal server where the remote application is resident.

15. A computer program product for use at a computer system, the computer program product for implementing a method for providing remote application access in accordance with decentralized configuration information, the computer program product comprising one or more computer-readable media having stored thereon computer-executable instructions that, when executed by a processor, cause the computer system to perform the following:
receive client side data from a client computer system, the client side data including at least an electronic address representing a request for a list of published remote applications targeted to user of the client computer system;
access one or more lists of available remote applications, each list including available remote applications resident at one or more terminal servers, each available application configured for remote execution over a terminal server connection between the client computer system and a corresponding terminal server;
access filters corresponding to each of the one or more terminal servers, each filter including filter criteria for filtering lists of available remote applications;
identify filter criteria to apply to the one or more lists of available remote applications based on the client side data;
apply the identified filter criteria to the one or more lists of available remote applications to reduce the one or more lists of available remote applications to a targeted subset of remote applications; and
return application access data for each remote application in the subset of remote applications to the client computer system such that the client computer system can use the application access data to remotely execute targeted remote applications.

16. At a Web server, a method for providing remote application access through a Web portal, the method comprising:
an act of receiving client side data from a client computer system, the client side data corresponding to a user of the client computer system, the client side data including a URL and being associated with a user ID for the user;
an act of accessing one or more lists of available remote applications, each list including available remote applications resident at one or more terminal servers, each available application configured for remote execution over a terminal server connection between the client computer system and a corresponding terminal server;
an act of accessing filters corresponding to each of the one or more terminal servers, each filter including filter criteria for filtering lists of available remote applications;
an act of identifying filter criteria to apply to the one or more lists of available remote applications based on the URL and the user ID;
an act of applying the identified filter criteria to the one or more lists of available remote applications to reduce the one or more lists of available remote applications to a subset of remote applications targeted to the URL and the user ID; and
an act of returning hyperlinks and installation data to the client computer system for each remote application in the subset such that the a Web browser at the client computer system can select a hyperlink to install a client side portion of a corresponding remote application.

17. The message as recited in claim 16, wherein the act of accessing one or more lists of available remote applications comprises an act of a accessing a list of available remote applications through a WMI interface.

18. The message as recited in claim 16, wherein the act of accessing one or more lists of available remote applications comprises an act of a accessing a list of available remote applications through an RSS interface.

19. The message as recited in claim 16, wherein the act of accessing one or more lists of available remote applications comprises an act of a accessing XML data representing remote applications resident at each of the one or more terminal servers.

20. The method as recited in claim 16, wherein the act of returning hyperlinks and installation data to the client computer system comprises an act of returning installation data that can be processed by an ActiveX® control at the client computer system to install the hyperlinks on the desktop of the client computer system.
